(19) United States
(12) Patent Application Publication
(10) Pub. No.: US 2026/0183854 A1
(43) Pub. Date: Jul. 2, 2026

(54) SYSTEMS, METHODS, AND DEVICES FOR REPROCESSING A BLADE TO CREATE A NEW SERRATED EDGE

(71) Applicant: Taylor Archibald, Riverton, UT (US)

(72) Inventor: Taylor Archibald, Riverton, UT (US)

(21) Appl. No.: 19/417,240

(22) Filed: Dec. 11, 2025

Related U.S. Application Data
(60) Provisional application No. 63/730,603, filed on Dec. 11, 2024.

(51) Int. Cl. B23D 65/02

(52) U.S. Cl. CPC B23D 65/02

(57) ABSTRACT

Systems, methods, and devices for reprocessing a blade to produce a new serrated edge. A system includes a stabilizer comprising a body, wherein the stabilizer comprises a hole formed in the body, wherein the hole extends a length of the stabilizer, and a blade slot formed in the body, wherein the blade slot is configured to receive the blade. The system includes a blade puncher configured to be disposed within the hole of the stabilizer, wherein the blade puncher comprises a plate and a plurality of serration ribs formed on a surface of the plate. The system is such that the blade puncher slides within the hole of the stabilizer to shear the edge of the blade when the blade is disposed within the blade slot.

### TECHNICAL FIELD

This application is directed to shearing systems and specifically to systems for shearing tool blades to enable blades to be reused.

### BACKGROUND

Oscillating tools (may also be referred to as a multi-tool) are commonly used across a wide range of construction tasks. Oscillating tools utilize rapid side-to-side motions to cut, grind, scrape, sand, and more. The tool is referred to as an “oscillating” tool because the blade or other attachment moves back and forth in a small arc at a high speed, typically about 20,000 oscillations per minute.

Oscillating tool blades can wear out quickly because the oscillating tool serves many purposes for cutting, scraping, and grinding a variety of substrates. For example, oscillating tools are commonly utilized to create flush cuts in various substrates such as wood, metal, plastic, sheetrock, ceramics, cement, porcelain, and so forth. Additionally, oscillating tools may be utilized to cut through hard materials, including nails, screws, and pipes. Oscillating tools may also be used to scrape adhesives, caulk, paint, flooring tiles, grout between tiles, and so forth. Because oscillating tools are commonly utilized to cut through hard substrates, and because oscillating tools are utilized for a wide range of tasks, construction workers are faced with frequently replacing the oscillating tool blade. This can be expensive and create unnecessary waste.

What is needed are means for repurposing an oscillating tool blade to extend the lifetime of the oscillating tool blade. In view of the foregoing, described herein are systems, methods, and devices for repurposing an oscillating tool blade by shearing the blade to create a new edge. The systems, methods, and devices described herein may be implemented to get numerous uses from a single oscillating tool blade prior to discarding and replacing the blade.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 is a schematic diagram of a system for reprocessing an oscillating tool blade to generate a new serrated edge on a distal end of the oscillating tool blade;

FIG. 2 is a schematic diagram of a blade reprocessing process to generate a sheared blade and sheared waste;

FIG. 3 is a schematic diagram of a system and method for reprocessing an oscillating tool blade to generate a new serrated edge on a distal end of the oscillating tool blade;

FIG. 4 is a perspective view of a blade shearing system for reprocessing an oscillating tool blade to generate a new serrated edge on a distal end of the oscillating tool blade;

FIG. 5 is a perspective view of a blade shearing system for reprocessing an oscillating tool blade to generate a new serrated edge on a distal end of the oscillating tool blade;

FIG. 6 is a straight-on aerial top-down view of a planar side of a plate of a blade puncher for reprocessing an oscillating tool blade to generate a new serrated edge on a distal end of the oscillating tool blade;

FIG. 7 is a perspective view of a blade puncher for reprocessing an oscillating tool blade to generate a new serrated edge on a distal end of the oscillating tool blade;

FIG. 8 is a perspective view of a blade puncher for reprocessing an oscillating tool blade to generate a new serrated edge on a distal end of the oscillating tool blade;

FIG. 9 is a perspective rear view of a stabilizer for reprocessing an oscillating tool blade to generate a new serrated edge on a distal end of the oscillating tool blade;

FIG. 10 is a straight-on end view of a stabilizer for reprocessing an oscillating tool blade to generate a new serrated edge on a distal end of the oscillating tool blade;

FIG. 11 is a straight-on cross-sectional side view of a stabilizer for reprocessing an oscillating tool blade to generate a new serrated edge on a distal end of the oscillating tool blade; and

FIG. 12 is a perspective cross-sectional view of a system for reprocessing an oscillating tool blade to generate a new serrated edge on a distal end of the oscillating tool blade.

### DETAILED DESCRIPTION

Disclosed herein are systems, methods, and devices for reprocessing and sharpening tool blades. Specifically described herein are systems, methods, and devices for shearing an oscillating tool blade to enable reuse of the blade with a fresh and sharp serrated edge. The systems, methods, and devices described herein may easily be implemented in the field to quickly remove an oscillating tool blade, reprocess the oscillating tool blade, and then reinstall and reuse the oscillating tool blade.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the systems, methods, and devices described herein are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting because the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

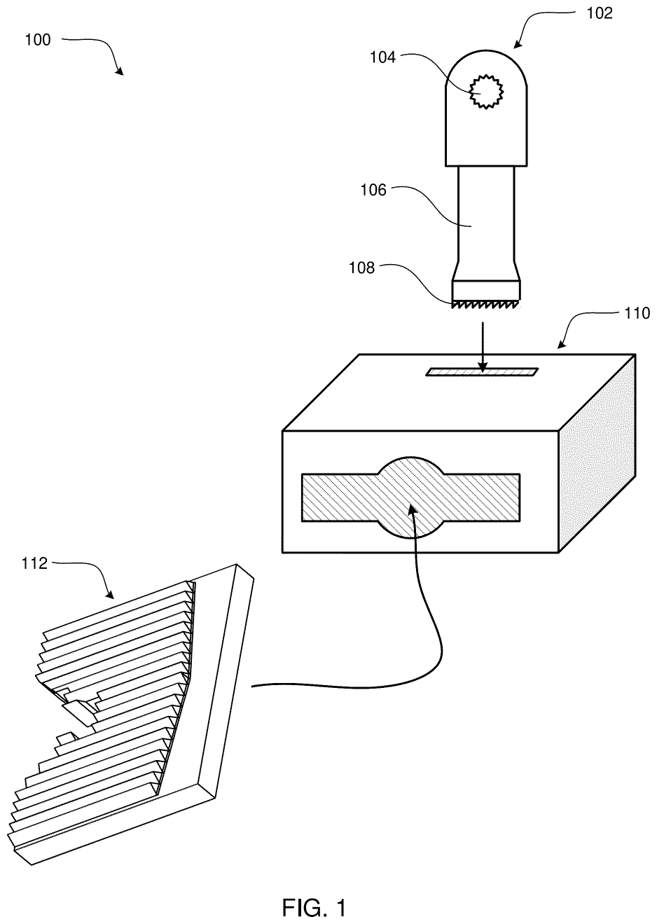

Referring now to the figures, FIG. 1 is a schematic illustration of a system 100 for reprocessing a blade 102 of an oscillating tool. The system 100 may be utilized to significantly extend the lifespan of the blade 102. In traditional systems, an oscillating tool blade is utilized until the blade becomes dull and inefficient, and then the blade is typically discarded and replaced. The system 100 enables a user to quickly shear the blade 102 to achieve a freshly sharpened edge. The blade 102 may then be immediately reused with the same effect as a new blade. The system 100 is designed such that oscillating tool blades 102 may be easily reprocessed in the field to quickly regain utilization of the oscillating tool.

The blade 102 comprises a substantially flat geometry and has a primary planal surface, which is visible in FIG. 1 in a straight-on view. The blade 102 includes a bore 104 for securely attaching the blade 102 to an oscillating tool. The bore 104 may comprise a keyed design cut into the planar surface of the blade 102 to ensure the blade 102 is securely attached to a corresponding keyed design on the oscillating tool. The blade 102 includes a planar blade shaft 106 and a serrated edge 108 at the proximal end of the planar blade shaft 106.

The blades 102 for oscillating tools may be designed to cut a wide variety of substrates, including, for example, softwood, hardwood, plywood, particle board, metal, plastic, grout, adhesives, paint, caulk, sheetrock, and so forth. The systems, methods, and devices described herein may be utilized to shear a blade 102 that is optimized to cut wood, or a blade 102 that is optimized to cut metal, or a blade 102 that is optimized to remove grout, or a blade 102 that is optimized to remove adhesives, or a blade 102 that is optimized to cut multiple materials such as wood, metal, and plastic. Additionally, the systems, methods, and devices described herein may be utilized to shear a blade 102 that is optimized for making plunge cuts, which may include narrow blades for cutting precise slots, holes, or channels in various substrates. The blade 102 may be constructed of various hard materials, including, for example, high-carbon steel (HCS) or bi-metal (BIM). Additionally, the blade 102 may be carbide tipped, or diamond coated.

The blade 102 is reprocessed by utilizing at least a stabilizer 110 and a blade puncher 112. The stabilizer 110 receives each of the blade 102 and the blade puncher 112 as shown in FIG. 1. When the blade puncher 112 and the blade 102 are properly disposed within the stabilizer 110, the primary plane of the blade 102 will be oriented substantially perpendicular to the primary plane of the blade puncher 112. The blade puncher 112 may then be forcefully pushed toward the blade 102 to shear off the existing serrated edge 108 of the blade 102. The blade puncher 112 additionally creates a new serrated edge 108 for the blade 102 that is sharp and ready to be utilized like a new blade.

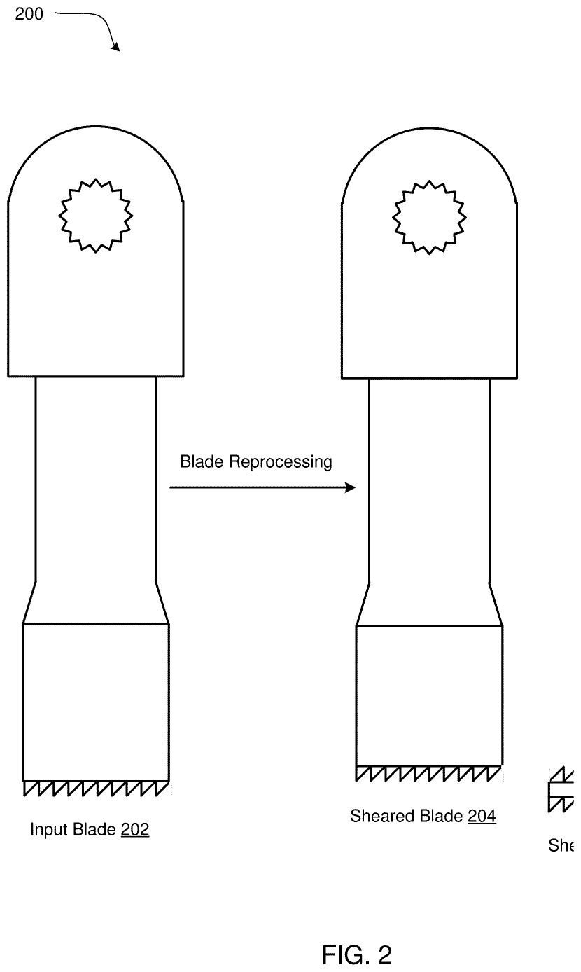

FIG. 2 is a schematic illustration of the result of blade reprocessing 200 as described herein. The blade reprocessing 200 described herein is performed on an input blade 202, which may include the features of the blade 102 described in connection with FIG. 1. The input blade 202 is inserted into a stabilizer (see 110) and sheared with a blade puncher (see 112). This results in a sheared blade 204 and sheared waste 206. The sheared waste 206 includes the serrated edge of the input blade 202, and additionally includes a negative correspondence of the new serrated edge of the sheared blade 204. The sheared waste 206 may be discarded and the sheared blade 204 may be installed into an oscillating tool for immediate use. In some cases, the sheared waste 206 includes only the dulled serrations removed from the blade. In some cases, the sheared waste 206 includes only the dulled serrations removed from blade and the negative correspondence of the new serrated edge of the sheared blade 204. In some cases, the sheared waste 206 may additionally include a straight portion of the input blade 202 that is sheared off.

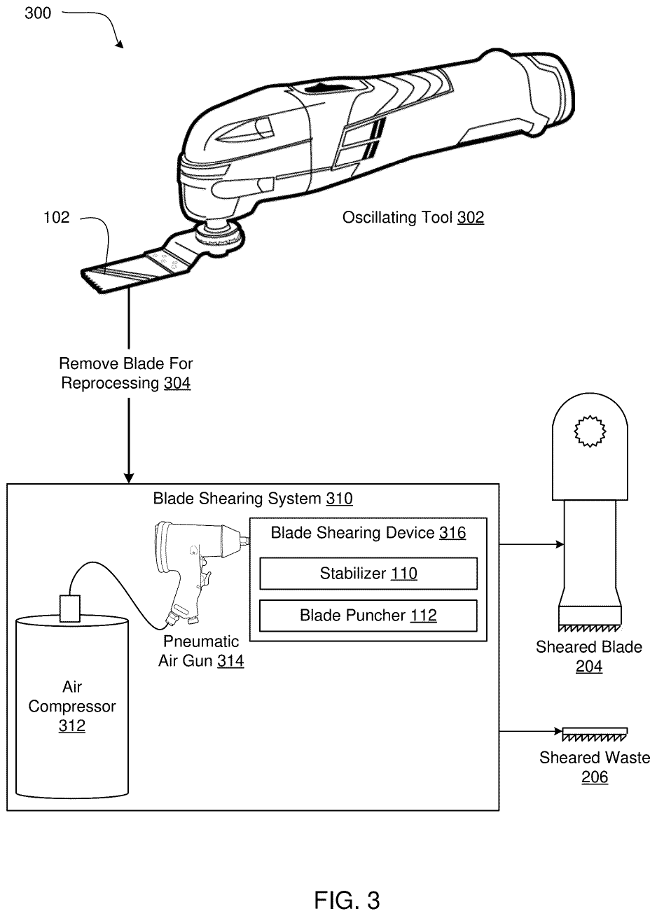

FIG. 3 is a schematic illustration of a method 300 for reprocessing an oscillating tool blade to enable reuse of the blade with a fresh and sharp edge. The method 300 is performed on a blade 102 of an oscillating tool 302. The blade 102 may include a serrated edge (see 108) enabling the blade 102 to quickly cut through a variety of substrates when the blade is oscillated back and forth by the oscillating tool 302. Depending on the substrate being cut, some blades 102 of oscillating tools 302 may become dull and unusable in a relatively short period of time. In traditional systems, the blade 102 must then be replaced, and this can quickly become prohibitively expensive. The method 300 illustrated in FIG. 3 enables a user to quickly reprocess the blade 102 and then immediately resume use of the oscillating tool 302.

The method 300 includes removing at 304 the blade 102 of the oscillating tool 302 to reprocess the blade for reuse with a fresh and sharp edge. The blade 102 is reprocessed with a blade shearing system 310. The blade shearing system 310 may include an air compressor 312, pneumatic air gun 314, and a blade shearing device 316, which includes at least the stabilizer 110 and the blade puncher 112. The pneumatic air gun 314 is attached to the blade shearing device 316 and may specifically be screwed into the stabilizer 110. The pneumatic air gun 314 is in fluid communication with the air compressor. The pneumatic air gun 314 is aligned with the blade puncher 112 of the blade shearing device 316, and the pneumatic air gun 314 is configured to release a short and forceful blast of compressed air. This forceful blast of compressed air moves the blade puncher 112 forward, and thus causes the blade puncher 112 to shear the blade 102.

The blade shearing system 310 outputs a sheared blade 204 that comprises a newly cut serrated edge. The blade shearing system 310 additionally outputs the sheared waste 206 that has been cut off the blade 102. For most blades 102 of oscillating tools 302, the method 300 may be performed numerous times before a blade needs to be replaced. In some implementations, the method 300 may be performed from about eight times to about 15 times on a singular blade 102, until the blade 102 needs to be replaced. Thus, the method 300 significantly increases the lifetime of oscillating tool blades.

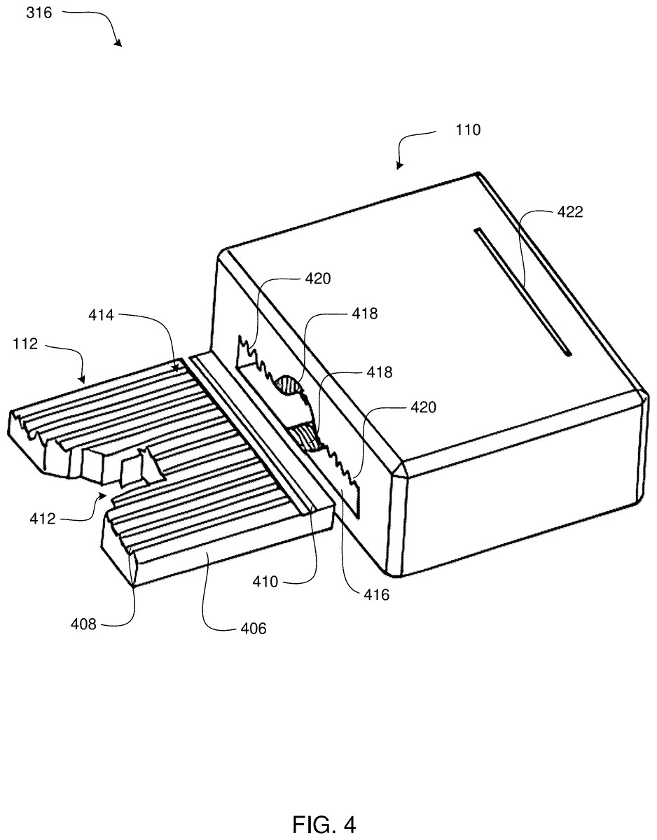

FIG. 4 is a perspective view of a blade shearing device 316. As shown in FIG. 3, the blade shearing device 316 may be hooked up to compressed air and utilized to quickly sheer the blade (see 102) of an oscillating tool (see 302). The blade shearing device 316 may be relatively small, such that the blade shearing device 316 is highly portable and may be brought into the field to quickly reprocess oscillating tool blades without significant disruption to work.

The blade shearing device 316 includes at least a blade puncher 112 and a stabilizer 110. The blade puncher 112 is configured to slide into a cavity within the stabilizer 110. The blade puncher 112 includes a plate 406 that includes a plurality of serration ribs 408 disposed on one planar side of the plate 406. The plurality of serration ribs 408 may collectively form a cross-sectional zig-zag pattern that is utilized to punch a fresh serrated edge on to a blade (see 102).

The serration ribs 408 collectively form an angled serration edge 414. The serration edge 414 is the edge of the serration ribs 408 that is responsible for cutting a new serrated edge on the blade (see 102). The serration edge 414 forms a pointed geometry, wherein the point of the pointed geometry is in the center of the serration edge 414. Thus, the blade (see 102) will first be struck by the center of the serration edge 414.

The blade puncher 112 additionally includes a blade stabilization channel 410. The blade stabilization channel 410 is a blind hole cut into a length of a planar surface of the plate 406. The blade stabilization channel 410 comprises a depth and width that are optimized for resting the proximal end of a blade (see 102) within the blade stabilization channel 410. The portion of the blade (see 102) that rests within the blade stabilization channel 410 will be sheared off from the blade (see 102) when the blade puncher 112 is rapidly pushed forward by the force of compressed air.

The blade puncher 112 includes a recess 412 cut into a distal end of the blade puncher 112. The recess 412 comprises a series of sides and cuts that are optimized for receiving a corresponding pneumatic air gun (see 314). During use, the pneumatic air gun (see 314) is disposed within the recess 412 of the blade puncher 112. Additionally, the pneumatic air gun (see 134) is screwed into the stabilizer 110.

The stabilizer 110 includes a blade slot 422 that is configured to receive a blade (see 102) of an oscillating tool (see 302). When the blade puncher 112 is installed within the stabilizer 110, the blade stabilization channel 410 is vertically aligned with the blade slot 422. Thus, the blade (see 102) may be disposed through the blade slot 422 and ultimately rest on the blade stabilization channel 410. The primary planar surface of the blade (see 102) will thus be oriented substantially perpendicular to the planar surface of the plate 406 of the blade puncher 112.

In some cases, the blade (see 102) of the oscillating tool (see 302) may first be sheared to remove the existing and dulled serration points. This shearing may thus output a blade with a flat and straight edge. To shear off only the existing and dulled serration points, without creating new serrations, the blade (see 102) may be placed within the blade stabilization channel 410 of the blade puncher 112. The blade puncher 112 may then be rapidly pushed forward to shear off the serrations of the blade that are disposed within the blade stabilization channel 410. The newly sheared blade, with the straight edge, may then be placed within the blade stabilization channel 410 and sheared again to create a newly serrated edge. In some cases, it may be recommended that a user manually remove the dull serrations with a grinder or sander prior to reprocessing the blade with the systems described herein.

The stabilizer 110 additionally includes a hollow interior. The geometry of the hollow interior is configured to receive a portion of a pneumatic air gun (see 314), and further receive the blade puncher 112. The hollow interior may include interior threading 418 configured to interface with corresponding external threading of the pneumatic air gun (see 314). Additionally, the hollow interior may include internal serrations 420 configured to receive the serration ribs 408 of the blade puncher 112. The hollow interior may include a bottom surface 416 that is flat and configured to allow the blade puncher 112 to easily slide forward and backward within the hollow interior of the stabilizer 110.

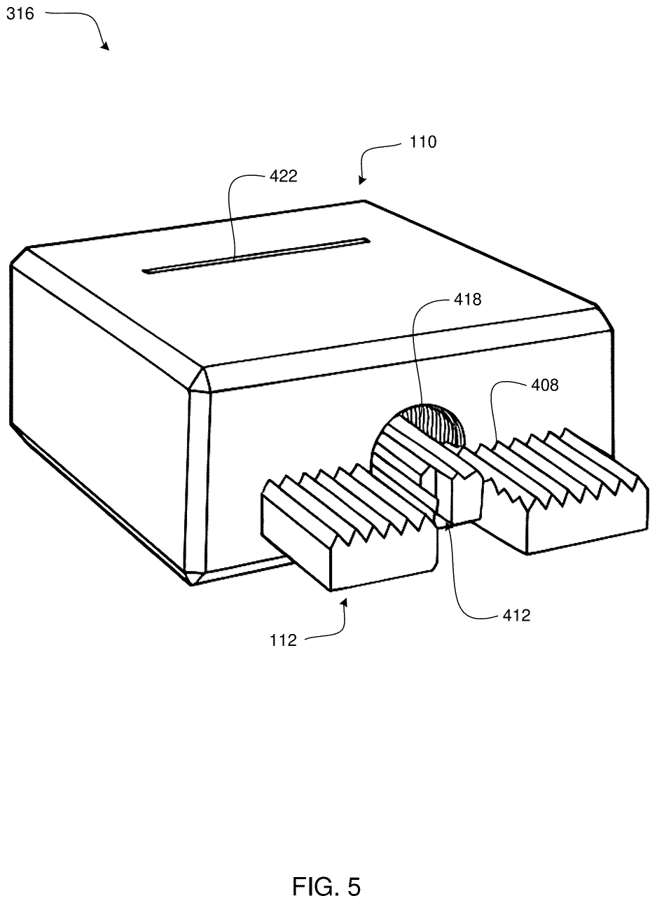

FIG. 5 is a perspective view of the blade shearing system 310 including the stabilizer 110 and the blade puncher 112. In the view illustrated in FIG. 5, the blade puncher 112 is partially disposed within the hollow interior defined by the body of the stabilizer 110.

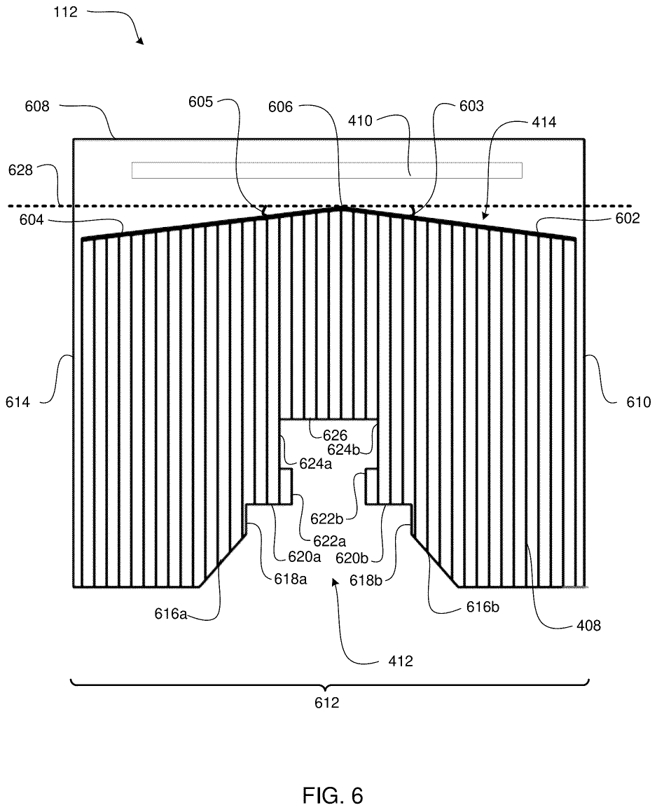

FIG. 6 is straight-on aerial top-down view of a blade puncher 112. The blade puncher 112 is configured to be utilized in connection with the blade shearing system 310. The blade puncher 112 is specifically responsible for shearing a blade (see 102) and creating a new serrated edge on a distal end of the blade (see 102).

The blade puncher 112 comprises a substantially quadrilateral geometry, wherein one side of the quadrilateral geometry is a complex side. The quadrilateral geometry includes a proximal side 608 (i.e., proximal to the blade when installed in the stabilizer) and a distal side 612 located opposite to the proximal side 608. The quadrilateral geometry additionally includes a first side 610 and a second side 614 that is located opposite to the first side 610. As shown in FIG. 6, the distal side 612 comprises a complex geometry that is configured to receive components of a pneumatic air gun (see 314). The complex distal side 612 includes the recess 412.

The complex distal side 612 includes a plurality of chamfers designed to correspond with components of a pneumatic air gun (see 314). The geometry of the recess 412 will be dependent upon the corresponding geometry of a pneumatic air gun (see 314), and it should be appreciated that the recess 412 may be altered without departing from the scope of the disclosure. The exemplary recess 412 illustrated in FIG. 6 includes a first chamfered edges 616a, 616b that are oriented on a diagonal relative to the fist side 610 and second side 614. The recess 412 may additionally include first perpendicular sides 618a, 618b that are oriented substantially perpendicular to the primary axis of the complex distal side 612. The recess 412 may include first complex parallel sides 620a, 620b that are oriented substantially parallel to the primary axis of the complex distal side 612. The recess 412 may include second perpendicular sides 622a, 622b that are oriented substantially perpendicular to the primary axis of the complex side 612. The recess 412 may include third perpendicular sides 624a, 624b that are oriented substantially perpendicular to the primary axis of the complex side 612. The recess 412 may include a proximal complex side 626 that is oriented substantially parallel to the complex distal side 612 and is disposed proximally to the blade (see 102) relative to the primary axis of the complex distal side 612. As described herein, items may be “substantially” perpendicular to one another if the items are oriented at 90-degrees relative to one another, plus or minus a 10% tolerance. Further as described herein, items may be “substantially” perpendicular to one another if the items are oriented parallel to one another, plus or minus a 10% tolerance.

The serration edge 414 includes a proximal point 606 that is located proximal to the blade (see 102) during operation. The proximal point 606 may be located in a center of the serration edge 414 as shown in FIG. 6. The serration edge 414 includes a first angled edge 602 and a second angled edge 604.

The first angled edge 602 defines a first angle 603, wherein the first angle 603 comprises a vertex at the proximal point 606, and wherein the first angle 603 is measured relative to a blade line 628. The blade line 628 is parallel to the proximal side 608 of the blade puncher 112, which is also parallel to blade stabilization channel 410 of the blade puncher 112. The second angled edge 604 defines a second angle 605, wherein the second angle 605 comprises a vertex at the proximal point 606 and is measured relative to the blade line 628.

The angled edges 602, 604 form a non-zero angle relative to the blade line 628. The angled edges 602, 604 may form the same angle relative to the blade line 628 or may form different angles relative to the blade line 628. The angled edges 602, 604 may form an angle from about 10 degrees to about 40 degrees relative to the blade line 628.

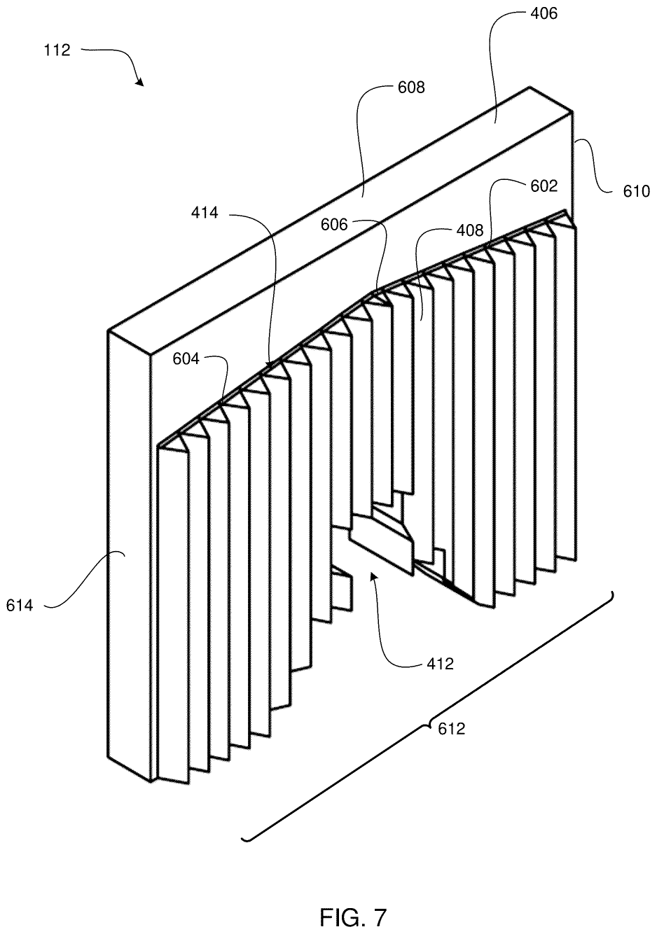

FIG. 7 is a perspective view of the blade puncher 112. The perspective view in FIG. 7 further illustrates the zig-zag pattern of the serration ribs 408 that extend outward and upward relative to a planar surface of the plate 406.

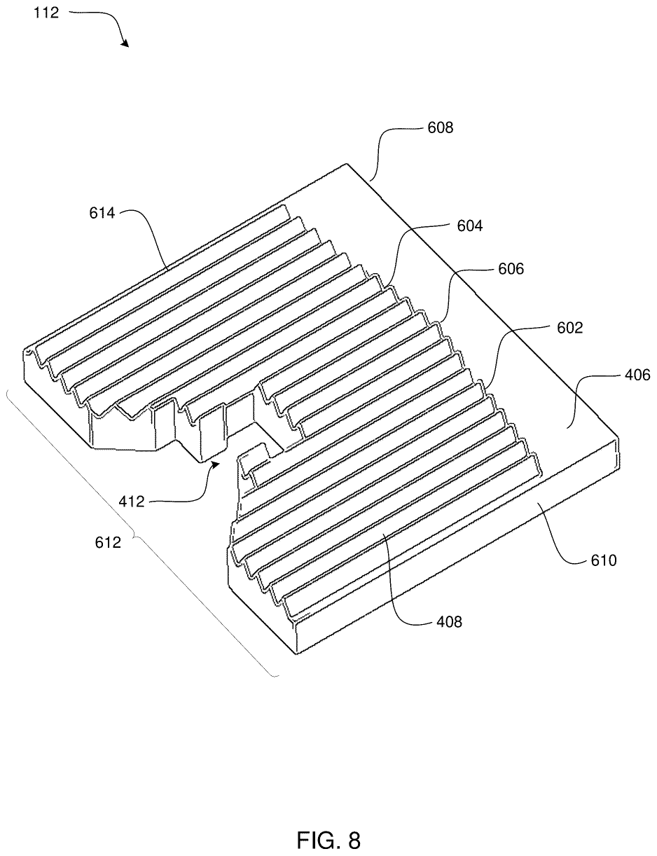

FIG. 8 is a perspective view of the blade puncher 112. The perspective view in FIG. 8 further illustrates the side of the recess 412 that form a portion of the complex distal side 612 of the plate 406. The recess 412 may be optimized to accommodate a certain pneumatic air gun (see 314). The recess 412 may be optimized a certain brand of pneumatic air gun (see 314). The recess 412 may be optimized to accommodate a plurality of different pneumatic air guns or brands of pneumatic air guns.

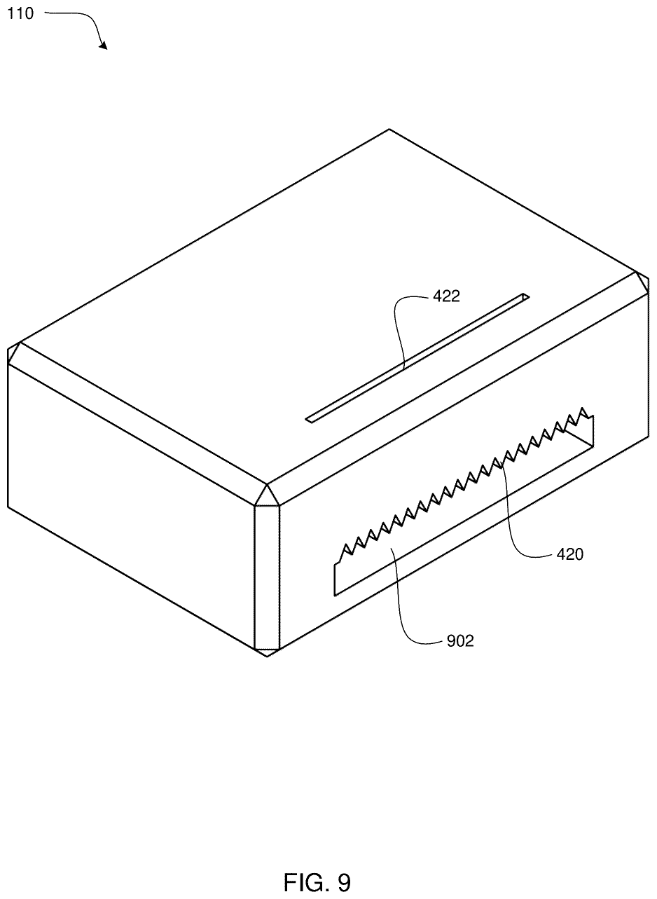

FIG. 9 is a perspective rear view of a stabilizer 110. The body of the stabilizer 110 includes a hole 902 that comprises a plurality of internal serrations 420. The hole 902 is disposed through an entire length of the stabilizer 110. The hole 902 begins on a distal end of the stabilizer 110 that is located distal to the blade (see 102) during operation. The distal end of the stabilizer 110 may be viewed in FIG. 4 and includes internal threading (see 418) for securing the stabilizer 110 to a pneumatic air gun (see 314). The entire length of the hole 902 includes the internal serrations 420 configured to accommodate the serration ribs (see 408) of the blade puncher (see 112).

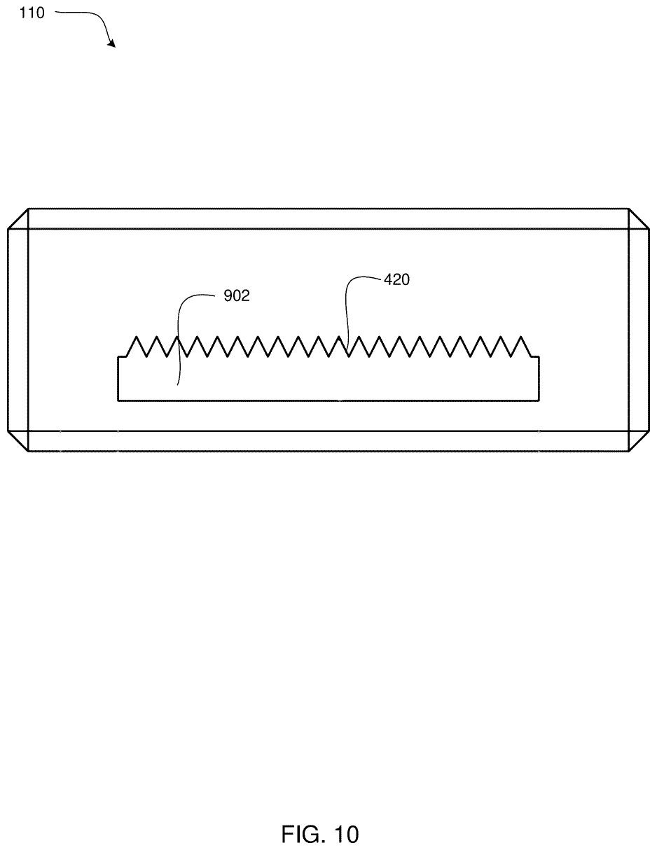

FIG. 10 is a straight-on proximal end view of the stabilizer 110. As shown in FIG. 10, the internal serrations 420 extend an entire length of the hole 902, both across the width of the hole 902, and along a length of the hole 902 from the distal end to the proximal end of the stabilizer 110.

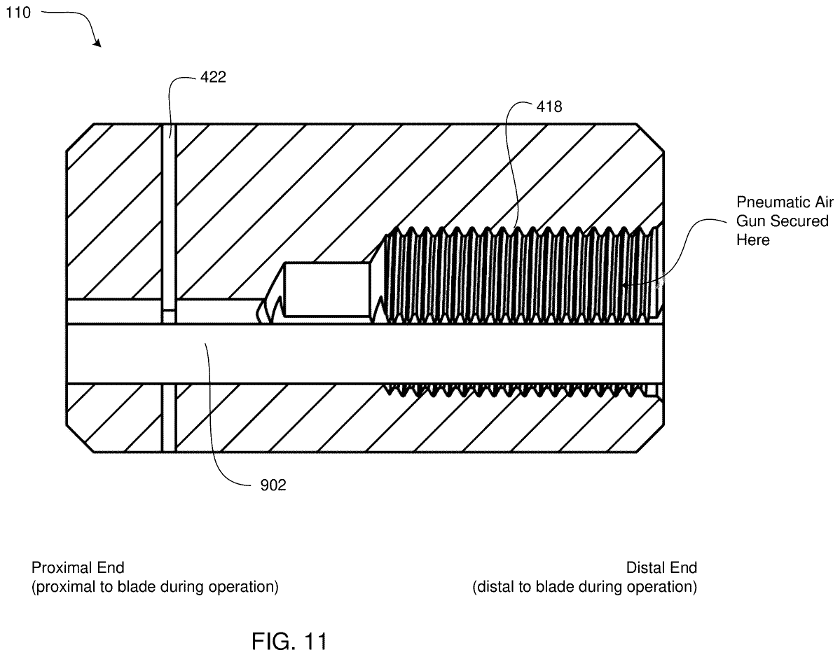

FIG. 11 is a straight-on cross-sectional side view of the stabilizer 110. FIG. 11 illustrates how the hole 902 extends an entire length of the stabilizer 110, from the proximal end to the distal end. FIG. 11 further illustrates the internal threading 418 configured to interface with corresponding external threading on a pneumatic air gun.

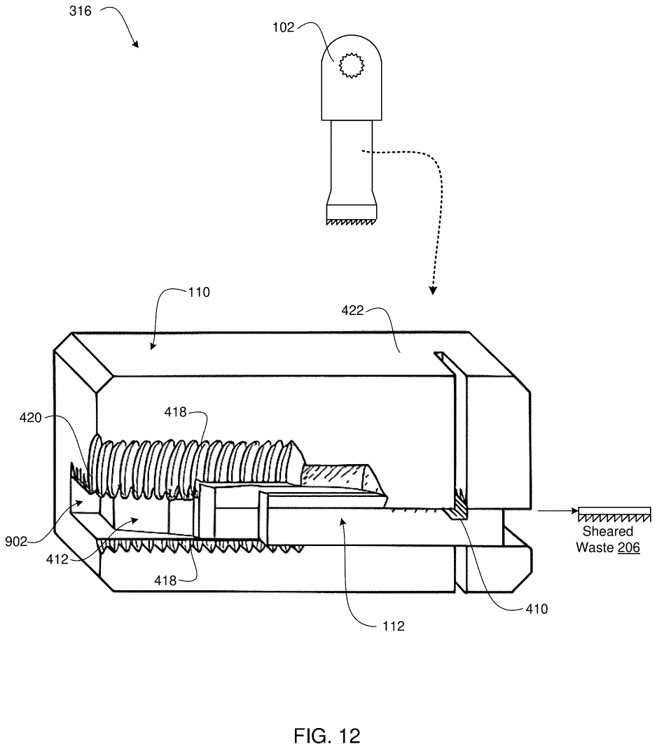

FIG. 12 is a perspective cross-sectional side view of a blade shearing device 316 including a stabilizer 110 and a blade puncher 112. FIG. 12 and additionally includes a straight-on side view of a blade 102 and a sheared waste 206 to illustrate an insertion location of the blade 102 and an exit location of the sheared waste 206.

FIG. 12 illustrates the blade puncher 112 disposed within the hole 902 of the stabilizer 110. FIG. 12 further illustrates the recess 412 formed in the blade puncher 112 for receiving a pneumatic air gun (see 314) that is configured to forcefully push the blade puncher 112 forward to shear off the sheared waste 206 from the input blade 102. FIG. 12 further illustrates the alignment of the blade slot 422 of the stabilizer and the blade stabilization channel 410 of the blade puncher 112. The blade 102 is configured to be disposed within the blade slot 422 and rest against the blade stabilization channel 410. When the pneumatic air gun forcefully pushes the blade puncher 112 forward, the sheared waste 206 will be sheared off and will exit the blade shearing device 316 as shown.

### Examples

The following examples pertain to further embodiments.
Example 1 is a system for shearing a blade. The system includes a stabilizer, wherein the stabilizer comprises a hole defined by a body. The system includes a blade puncher, wherein the blade puncher is configured to be disposed within the hole of the stabilizer.
Example 2 is a system as in Example 1, wherein the stabilizer comprises internal threading configured to interface with external threading of a pneumatic air gun to removably secure the pneumatic air gun to the stabilizer.
Example 3 is a system as in any combination of any of Examples 1-2, wherein the stabilizer further comprises a blade slot, wherein the blade slot comprises a blind hole disposed within the body of the stabilizer.
Example 4 is a system as in any combination of any of Examples 1-3, wherein the blade slot is oriented substantially perpendicular to the hole of the stabilizer.
Example 5 is a system as in any combination of any of Examples 1-4, wherein the blade slot is configured to receive a blade of an oscillating tool.
Example 6 is a system as in any combination of any of Examples 1-5, wherein the blade puncher comprises a plate, and wherein the blade puncher comprises a plurality of serration ribs formed on a planar surface of the plate.
Example 7 is a system as in any combination of any of Examples 1-6, wherein the plurality of serration ribs are configured to form serrations on a distal end of a blade of an oscillating tool.
Example 8 is a system as in any combination of any of Examples 1-7, wherein the blade puncher further comprises a blade stabilization channel, wherein the blade stabilization channel comprises a blind hole formed in the plate of the blade puncher, and wherein the blade stabilization channel is configured to receive a distal end of a blade of an oscillating tool.
Example 9 is a system as in any combination of any of Examples 1-8, wherein the blade puncher comprises a quadrilateral geometry with a complex side, and wherein the complex side is configured to receive a pneumatic air gun.
Example 10 is a system as in any combination of any of Examples 1-9, wherein the stabilizer is configured to be releasably secured to the pneumatic air gun, and wherein the stabilizer is configured to be disposed in front of the pneumatic air gun such that an air blast emitted by the pneumatic air gun causes the blade puncher to rapidly slide away from the pneumatic air gun.
Example 11 is a system as in any combination of any of Examples 1-10, wherein, in response to a blade of an oscillating tool being disposed within the blade slot of the stabilizer and the blade stabilization channel of the blade puncher, the air blast emitted by the pneumatic air gun causes the blade puncher to rapidly slide away from the pneumatic air gun and shear off a sheared waste from the blade of the oscillating tool.
Example 12 is a system for reprocessing an edge of a blade. The system includes a stabilizer comprising a body, wherein the stabilizer comprises: a hole formed in the body, wherein the hole extends a length of the stabilizer; and a blade slot formed in the body, wherein the blade slot is configured to receive the blade. The system includes a blade puncher configured to be disposed within the hole of the stabilizer, wherein the blade puncher comprises: a plate; a plurality of serration ribs formed on a surface of the plate. The system is such that the blade puncher slides within the hole of the stabilizer to shear the edge of the blade when the blade is disposed within the blade slot.
Example 13 is a system as in Example 12, wherein the blade is an oscillating tool blade, and wherein the edge of the oscillating tool blade comprises a serrated edge; and wherein the blade stabilization channel of the blade puncher is configured to receive the serrated edge of the oscillating tool blade.
Example 14 is a system as in any combination of any of Examples 12-13, wherein the stabilizer comprises internal threading configured to interface with external threading of a pneumatic air gun to removably secure the pneumatic air gun to the stabilizer.
Example 15 is a system as in any combination of any of Examples 12-14, wherein an air blast emitted by the pneumatic air gun causes the blade puncher to slide away from the pneumatic air gun within the hole of the stabilizer; and wherein the blade puncher sliding away from the pneumatic air gun causes the blade puncher to shear the edge of the blade.
Example 16 is a system as in any combination of any of Examples 12-15, wherein the blade slot is a blind hole formed in the body of the stabilizer.
Example 17 is a system as in any combination of any of Examples 12-16, wherein a longitudinal axis of the blade slot is oriented perpendicular to a longitudinal axis of the hole of the stabilizer, within a tolerance threshold of ten percent.
Example 18 is a system as in any combination of any of Examples 12-17, wherein the blade stabilization channel is a blind hole formed in the plate of the blade puncher.
Example 19 is a system as in any combination of any of Examples 12-18, wherein the body of the stabilizer comprises internal serrations extending into the hole along the length of the stabilizer; and wherein the plurality of serration ribs of the blade puncher correspond with the internal serrations of the stabilizer such that the blade puncher slides freely within the hole of the stabilizer.
Example 20 is a system as in any combination of any of Examples 12-19, wherein the blade puncher comprises a recess formed on a side of the plate; wherein the recess is configured to receive a pneumatic air gun; and wherein an air blast emitted by the pneumatic air gun into the recess causes the blade puncher to slide away from the pneumatic air gun and shear the edge of the blade.
Example 21 is a system as in any combination of any of Examples 12-20, wherein the plurality of serration ribs of the blade puncher are configured to create a plurality of teeth on the edge of the blade.
Example 22 is a system as in any combination of any of Examples 12-21, wherein the blade slot of the stabilizer and the blade stabilization channel of the blade puncher are aligned such that the blade extends through each of the blade slot and the blade stabilization channel when positioned for reprocessing.
Example 23 is a system as in any combination of any of Examples 12-22, wherein the blade comprises a worn serrated edge prior to reprocessing, and wherein the blade comprises a freshly serrated edge after reprocessing with the system.
Example 24 is a system as in any combination of any of Examples 12-23, wherein the plurality of serration ribs of the blade puncher form a serration edge for reprocessing the blade; and wherein the serration edge comprises a proximal point located proximally to the blade when the blade is installed within the blade stabilization channel.
Example 25 is a system as in any combination of any of Examples 12-24, wherein the serration edge comprises a first angled edge and a second angled edge; wherein the first angled edge defines a first angle comprising a first vertex at the proximal point, wherein the first angle is measured relative to a blade line that is oriented parallel to a longitudinal axis of the blade stabilization channel; wherein the second angled edge defines a second angle comprising a second vertex at the proximal point, wherein the second angle is measured relative to the blade line.
Example 26 is a system as in any combination of any of Examples 12-25, wherein each of the first angle and the second angle is a non-zero angle.
Example 27 is a system as in any combination of any of Examples 12-26, wherein one or more of the first angle or the second angle is from ten degrees to forty degrees.
Example 28 is a system as in any combination of any of Examples 12-27, wherein the first angle is equal to the second angle within a tolerance threshold of ten percent.
Example 29 is a system as in any combination of any of Examples 12-28, wherein the blade slot formed in the body of the stabilizer provides lateral stabilization to the blade during reprocessing to prevent the blade from deflecting perpendicular to a shearing direction.
Example 30 is a system as in any combination of any of Examples 12-29, wherein the hole formed in the body of the stabilizer defines an exit path through which a sheared waste portion exits the stabilizer after being separated from the blade during reprocessing.
Example 31 is a system as in any combination of any of Examples 12-30, wherein a longitudinal axis of the blade stabilization channel is oriented perpendicular to a longitudinal axis of the hole formed in the body of the stabilizer, such that movement of the blade puncher along the longitudinal axis of the hole causes the plurality of serration ribs to shear through the blade.
Example 32 is a system as in any combination of any of Examples 12-31, wherein the blade puncher further comprises a blade stabilization channel formed in the plate; wherein the blade stabilization channel is configured to receive the edge of the blade; and wherein the blade puncher slides within the hole of the stabilizer to shear the edge of the blade when the blade is disposed within the blade slot and the blade stabilization channel.
Example 33 is a system as in any combination of any of Examples 12-32, wherein the blade is an oscillating tool blade, and wherein the edge of the oscillating tool blade comprises a serrated edge; and wherein the blade stabilization channel of the blade puncher is configured to receive the serrated edge of the oscillating tool blade.

It is to be understood that any features of the above-described arrangements, examples, and embodiments may be combined in a single embodiment comprising a combination of features taken from any of the disclosed arrangements, examples, and embodiments.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements.

Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A system for reprocessing an edge of a blade, wherein the system comprises:
a stabilizer comprising a body, wherein the stabilizer comprises:
a hole formed in the body, wherein the hole extends a length of the stabilizer; and
a blade slot formed in the body, wherein the blade slot is configured to receive the blade; and
a blade puncher configured to be disposed within the hole of the stabilizer, wherein the blade puncher comprises:
a plate;
a plurality of serration ribs formed on a surface of the plate; and
wherein the blade puncher slides within the hole of the stabilizer to shear the edge of the blade when the blade is disposed within the blade slot.

2. The system of claim 1, wherein the blade puncher further comprises a blade stabilization channel formed in the plate;
wherein the blade stabilization channel is configured to receive the edge of the blade; and
wherein the blade puncher slides within the hole of the stabilizer to shear the edge of the blade when the blade is disposed within the blade slot and the blade stabilization channel.

3. The system of claim 2, wherein the blade is an oscillating tool blade, and wherein the edge of the oscillating tool blade comprises a serrated edge; and
wherein the blade stabilization channel of the blade puncher is configured to receive the serrated edge of the oscillating tool blade.

4. The system of claim 1, wherein the stabilizer comprises internal threading configured to interface with external threading of a pneumatic air gun to removably secure the pneumatic air gun to the stabilizer.

5. The system of claim 4, wherein an air blast emitted by the pneumatic air gun causes the blade puncher to slide away from the pneumatic air gun within the hole of the stabilizer; and
wherein the blade puncher sliding away from the pneumatic air gun causes the blade puncher to shear the edge of the blade.

6. The system of claim 1, wherein the blade slot is a blind hole formed in the body of the stabilizer.

7. The system of claim 1, wherein a longitudinal axis of the blade slot is oriented perpendicular to a longitudinal axis of the hole of the stabilizer, within a tolerance threshold of ten percent.

8. The system of claim 2, wherein the blade stabilization channel is a blind hole formed in the plate of the blade puncher.

9. The system of claim 1, wherein the body of the stabilizer comprises internal serrations extending into the hole along the length of the stabilizer; and
wherein the plurality of serration ribs of the blade puncher correspond with the internal serrations of the stabilizer such that the blade puncher slides freely within the hole of the stabilizer.

10. The system of claim 1, wherein the blade puncher comprises a recess formed on a side of the plate;
wherein the recess is configured to receive a pneumatic air gun; and
wherein an air blast emitted by the pneumatic air gun into the recess causes the blade puncher to slide away from the pneumatic air gun and shear the edge of the blade.

11. The system of claim 1, wherein the plurality of serration ribs of the blade puncher are configured to create a plurality of teeth on the edge of the blade.

12. The system of claim 2, wherein the blade slot of the stabilizer and the blade stabilization channel of the blade puncher are aligned such that the blade extends through each of the blade slot and the blade stabilization channel when positioned for reprocessing.

13. The system of claim 1, wherein the blade comprises a worn serrated edge prior to reprocessing, and wherein the blade comprises a freshly serrated edge after reprocessing with the system.

14. The system of claim 2, wherein the plurality of serration ribs of the blade puncher form a serration edge for reprocessing the blade; and
wherein the serration edge comprises a proximal point located proximal to the blade when the blade is installed within the blade stabilization channel.

15. The system of claim 14, wherein the serration edge comprises a first angled edge and a second angled edge;
wherein the first angled edge defines a first angle comprising a first vertex at the proximal point, wherein the first angle is measured relative to a blade line that is oriented parallel to a longitudinal axis of the blade stabilization channel;
wherein the second angled edge defines a second angle comprising a second vertex at the proximal point, wherein the second angle is measured relative to the blade line; and
wherein each of the first angle and the second angle is a non-zero angle.

16. The system of claim 15, wherein one or more of the first angle or the second angle is from ten degrees to forty degrees.

17. The system of claim 15, wherein the first angle is equal to the second angle within a tolerance threshold of ten percent.

18. The system of claim 1, wherein the blade slot formed in the body of the stabilizer provides lateral stabilization to the blade during reprocessing to prevent the blade from deflecting perpendicular to a shearing direction.

19. The system of claim 1, wherein the hole formed in the body of the stabilizer defines an exit path through which a sheared waste portion exits the stabilizer after being separated from the blade during reprocessing.

20. The system of claim 2, wherein a longitudinal axis of the blade stabilization channel is oriented perpendicular to a longitudinal axis of the hole formed in the body of the stabilizer, such that movement of the blade puncher along the longitudinal axis of the hole causes the plurality of serration ribs to shear through the blade.
